(19) United States
(12) Patent Application Publication
(10) Pub. No.: US 2015/0240024 A1
(43) Pub. Date: Aug. 27, 2015

(54) POLYISOCYANATE-POLYADDITION PRODUCTIONS

(71) Applicant: BAYER MATERIALSCIENCE AG, Leverkusen (DE)

(72) Inventors: Frank Richter, Leverkusen (DE); Michael Grahl, Leverkusen (DE); Olaf Fleck, Bergisch-Gladbach (DE)

(73) Assignee: BAYER MATERIALSCIENCE AG, Leverkusen (DE)

(21) Appl. No.: 14/430,325

(22) PCT Filed: Sep. 23, 2013
(86) PCT No.: PCT/EP2013/069730

§ 371 Date: Mar. 23, 2015

(30) Foreign Application Priority Data
Sep. 25, 2012 (EP) 12185928.4

(51) Int. Cl. C08G 18/24; C08G 18/28; C09D 175/08; C08G 18/73

(52) U.S. Cl. CPC C08G 18/24; C08G 18/73; C08G 18/2835; C09D 175/08

(57) ABSTRACT

The invention relates to polyisocyanate polyaddition products and to the use of specific catalysts for their preparation, and to their use, in particular for the coating sector.

The invention relates to polyisocyanate polyaddition products and to the use of specific catalysts for their preparation, and to their use, in particular for the coating sector.

Polyurethane coatings have been known for a long time and are used in many fields. They are generally prepared from a polyisocyanate component and a hydroxyl component by mixing immediately before application (2K technology). For light-fast coatings there are generally used polyisocyanate components based on aliphatic polyisocyanates which, in comparison with products having aromatically bonded isocyanate groups, enter significantly more slowly into reaction with the hydroxyl component. In most cases, the reaction must therefore be catalysed, in particular when it is not possible or desirable to use very high reaction temperatures, even if heating is carried out where possible to further accelerate the reaction. Organic tin compounds, in particular dibutyltin dilaurate (DBTL), have proved to be successful as catalysts. Organotin compounds by definition have at least one Sn—C bond in the molecule. They have the general disadvantage of an unfavourable ecological profile, which has already led inter alia to the substance class of the organotin compounds being banned completely from marine paints, to which they were added as a biocide.

Organotin-free catalysts for the preparation of polyurethanes were and are therefore the focus of new developments. Such developments frequently turn to elements whose toxicological profile per se is judged to be less critical compared with organotin compounds, for example bismuth, titanium or zinc. A disadvantage of all those catalysts is, however, that they are not as universally usable as organotin compounds. Many of the catalysts discussed as alternatives exhibit disadvantages through to the complete loss of catalytic activity in a number of fields of application. Examples are the rapid hydrolysis of bismuth compounds in aqueous media, which renders them of no interest for the field of water-based coating technologies, which is becoming increasingly important now and in the future, and the sometimes unsatisfactory colour effects of titanium compounds in some lacquer formulations.

A general disadvantage of 2K technology is further that the NCO—OH reaction already takes place slowly at room temperature but significantly more quickly when catalysed, which has the result that only a very narrow processing window is available in terms of time for processing of the formulated mixture of such a 2K system (the so-called pot life), which is further shortened by the presence of the catalyst.

There has therefore been no lack of attempts to develop catalysts which scarcely accelerate the crosslinking reaction during preparation of the 2K mixture but accelerate it significantly after application (latent catalysts), and which thereby yield comparable results largely independently of the chosen field of application.

The term thermolatency is used in connection with catalysts when their catalytic activity only manifests itself when a temperature characteristic for the catalyst in question is exceeded.

A class of latent catalysts which is used in particular in the field of cast elastomers are organomercury compounds. The most prominent representative is phenylmercury neodeeanoate (trade names: Thorcat® 535, Cocure® 44). Inter alia because of the toxicology of the mercury compounds, however, they play no role in coating technology. Their use is also increasingly being questioned in other fields of application.

The focus here has instead been on systems which are activatable chemically, for example by (atmospheric) moisture and/or oxygen (see WO 2007/075561, Organometallics 1994 (13) 1034-1038, DE-A 69521682) and photochemically (see U.S. Pat. No. 4,549,945). A disadvantage of the two last-mentioned systems of the prior art is on the one hand that it is difficult to ensure a defined, reproducible migration of (atmospheric) moisture or oxygen independently of the coating formulation (degree of crosslinking, glass transition temperature, solvent content, etc.) and of the ambient conditions and on the other hand that, in particular in the case of pigmented systems, there are limits to the use of radiation sources for activating the photolatent catalyst.

WO 2011/051247 describes the use of specific inorganic Sn(IV) catalysts for overcoming the above-mentioned pot life/curing time problem.

A disadvantage of those catalysts is the sometimes significantly lower activity compared with standard catalysts such as dibutyltin dilaurate with the same (molar) amount of inorganic tin catalyst, see WO 2011/051247, Examples 7, 8 and 10 to 14: in no case, starting at 30° C. for 2 hours and then at 60° C., did the NCO content reach or fall below the NCO content of the mixture achieved in comparative test 4 with the equimolar amount of DBTL and using the same procedure (1.1% after 4 hours). In order to achieve that, the reaction temperature had to be increased after the 30° C. phase to 80° C., WO 2011/051247, Examples 9 and 15.

Although the reactivity can in principle be increased, apart from by raising the temperature (which is not universally possible to the same extent), by increasing the catalyst concentration, the latency surprisingly suffers thereby (Examples 5 to 8), which moreover is not mentioned in WO 2011/051247.

Although the latter circumstance in principle opens up access to universally usable, organotin-free and thus toxicologically harmless catalysts, endeavours are made in practice to manage with as little catalyst as possible, and a purposive “overdosing” of the catalyst—simply in order to suppress the effect of thermolatency and effect sufficient acceleration of the reaction even at room temperature—will therefore be accepted only unwillingly. In addition, many of the inorganic tin compounds mentioned in WO 2011/051247 have only low solubility in the organic medium of the polyurethane starting materials, which is already an obstacle to the use of very large amounts of catalyst (the catalyst concentration mentioned in Example 8 is in the region of the saturation concentration of the catalyst in the polyisocyanate chosen here). Although these deficiencies in solubility can be counteracted by suitable substitution of the organic radicals in the claimed compounds, on the one hand the content of “active” central atom (Sn) falls at the same time, and on the other hand the preparation of the species becomes more complex and more expensive because it is no longer possible, as in the simplest case, to use for their preparation inexpensive ethanolamine derivatives such as N(CH₂CH₂OH)₃ or CH₃N(CH₂OH)₂ which are readily available commercially. Finally, specifically in the case of the most active of the catalysts claimed in WO 2011/051247, in particular catalyst 3, which is used therein in Example 7, only limited stability of the catalysed polyisocyanate component is observed—particularly at a relatively high storage temperature—which is likewise disadvantageous (Example 22a of the present application).

Furthermore, the primary products of a particularly simple and thus inexpensive synthesis method for the inorganic tin compounds claimed as a catalyst class in WO 2011/051247, that is to say Sn(IV)-centred spirocycles, see WO 2011/113926, exhibit particularly poor activity, which makes their use as catalysts according to WO 2011/051247 appear unpromising. However, their catalytic activity for the reaction, which here is undesirable, of the isocyanate groups with one another is reduced significantly compared with the catalyst type used in Example 22a of the present application, which is advantageous (see Example 22b of the present application).

The object was, therefore, to bring the advantages of the thermolatent catalysts mentioned in WO 2011/051247 to bear at as low a (molar) catalyst concentration as possible, that is to say to maintain them at a comparable or even improved level compared with the prior-known, conventional organotin-based systems, without having to accept far too great disadvantages in terms of the storage stability of the catalysed isocyanate component. Furthermore, it is to be possible to use therefor, without difficulty, inorganic, halogen-free, Sn(IV)-centred spirocycles, the synthesis of which is described, for example, in WO 2011/113926, Example 3.

Surprisingly, it has been possible to achieve that object by adding protonic acids to the reaction mixture.

Accordingly, the invention provides polyisocyanate polyaddition products obtainable from
a) at least one aliphatic, cycloaliphatic, araliphatic and/or aromatic polyisocyanate,
b) at least one NCO-reactive compound,
c) at least one thermolatent, inorganic, tin-comprising catalyst,
d) optionally further catalysts and/or activators other than e),
e) optionally fillers, pigments, additives, thickeners, antifoams and/or other auxiliary substances and added ingredients, and
f) a protic acid in an amount which is at least equimolar based on the catalyst mentioned under c) and not more than equimolar based on the NCO-reactive groups from the compound from b),
   wherein the ratio of the weight of the tin from component c) and of the weight of component a) is less than 1000 ppm when component a) is an aliphatic polyisocyanate and less than 80 ppm when component a) is an aromatic polyisocyanate,

characterised in that there are used as thermolatent catalysts e) cyclic tin compounds of formula I, II or III:

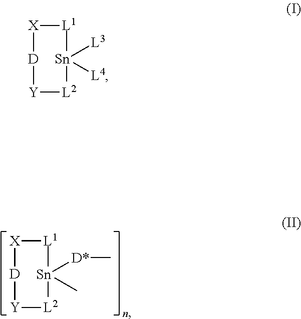

where n>1,

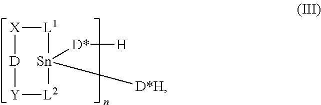

where n>1,
wherein:
D represents —O—, —S— or —N(R¹)—,
   wherein R¹ represents a saturated or unsaturated, linear or branched, aliphatic or cycloaliphatic or an optionally substituted, aromatic or araliphatic radical having up to 20 carbon atoms, which can optionally comprise heteroatoms from the group oxygen, sulfur, nitrogen, or represents hydrogen or the radical

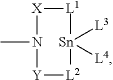

or R¹ and L³ together represent —Z-L⁵-;
D* represents —O— or —S—;
X, Y and Z represent the same or different radicals selected from alkylene radicals of the formulae —C(R²)(R³)—, —C(R²)(R³)—C(R⁴)(R⁵)— or —C(R²)(R³)—C(R⁴)C(R⁵)—C(R⁶)(R⁷)— or ortho-arylene radicals of the formula

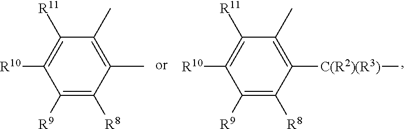

wherein R² to R ¹¹ independently of one another represent saturated or unsaturated, linear or branched, aliphatic or cycloaliphatic or optionally substituted, aromatic or araliphatic radicals having up to 20 carbon atoms, which can optionally comprise heteroatoms from the group oxygen, sulfur, nitrogen, or represent hydrogen;
L¹, L² and L⁵ independently of one another represent —O—, —S—, —OC(═O)—, —OC(═S)—, —SC(═O)—, —SC(═S)—, —OS(═O)₂O—, —OS(═O₂— or —N(R¹²)—,
   wherein R¹² represents a saturated or unsaturated, linear or branched, aliphatic or cycloaliphatic or an optionally substituted, aromatic or araliphatic radical having up to 20 carbon atoms, which can optionally comprise heteroatoms from the group oxygen, sulfur, nitrogen, or represents hydrogen;
L³ and L⁴ independently of one another represent —OH, —SH, —OR¹³ , -Hal, —OC(═O)R¹⁴, —SR¹⁵, —OC(═S)R¹⁶, —OS(═O)₂OR¹⁷, —OS(═O)₂R¹⁸ or —NR¹⁹R²⁰, or L³ and L⁴ together represent -L¹-X-D-Y-L²-, preferably L³ and L⁴ independently of one another represent —OR¹³, -Hal, —OC(═O)R¹⁴, or L³ and L⁴ together represent -L-X-D-Y-L²-,
   wherein R¹³ to R²⁰ independently of one another represent saturated or unsaturated, linear or branched, aliphatic or cycloaliphatic or optionally substitured, aromatic or araliphatic radicals having up to 20 carbon atoms, which can optionally comprise heteroatoms from the group oxygen, sulfur, nitrogen, or represent hydrogen.
Preferably, D is —N(R¹)—.
Preferably, R¹ is hydrogen or an alkyl, aralkyl, alkaryl or aryl radical having up to 20 carbon atoms, or
the radical

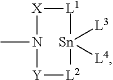

particularly preferably hydrogen or an alkyl, aralkyl, alkaryl or aryl
radical having up to 12 carbon atoms, or the radical

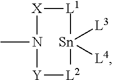

most particularly preferably hydrogen or a methyl, ethyl, propyl, butyl, hexyl or octyl radical, wherein propyl, butyl, hexyl and octyl represent all isomeric propyl, butyl, hexyl and octyl radicals, Ph-, CH₃Ph- or the radical

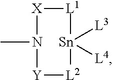

Preferably, D* is —O—.
Preferably, X, Y and Z are the alkylene radicals —C(R²)(R³)—, —C(R2)(R³)—C(R⁴)(R⁵)— or the ortho-arylene radical

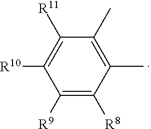

Preferably, R² to R⁷ are hydrogen or alkyl, aralkyl, alkaryl or aryl radicals having up to 20 carbon atoms, particularly preferably hydrogen or alkyl, aralkyl, alkaryl or aryl radicals having up to 8 carbon atoms, most particularly preferably hydrogen or alkyl radicals having up to 8 carbon atoms, yet more preferably hydrogen or methyl,

Preferably, R⁸ to R¹¹ are hydrogen or alkyl radicals having up to 8 carbon atoms, particularly preferably hydrogen or methyl.

Preferably, L¹, L² and L⁵ are —NR¹²—, —S—, —SC(═S)—, —SC(═O)—, —OC(═S)—, —O—, or —OC(═O)—, particularly preferably —O— or —OC(═O)—.

Preferably, R¹² is hydrogen or an alkyl, aralkyl, alkaryl or aryl radical having up to 20 carbon atoms, particularly preferably hydrogen or an alkyl, aralkyl, alkaryl or aryl radical having up to 12 carbon atoms, most particularly preferably hydrogen or a methyl, ethyl, propyl, butyl, hexyl or octyl radical, wherein propyl, butyl, hexyl and octyl represent all isotneric propyl, butyl, hexyl and octyl radicals.

Preferably, L³ and L⁴ are -Hal, —OH, —SH, —OR¹³, —OC(═)R¹⁴, wherein the radicals R¹³ and R¹⁴ contain up to 20 carbon atoms, preferably up to 12 carbon atoms.

Particularly preferably, L³ and L⁴ are Cl—, MeO—, EtO—, PrO—, BuO—, HexO—, OctO—, PhO—, formate, acetate, propanoate, butanoate, pentanoate, hexanoate, octanoate, laurate, lactate or benzoate, wherein Pr, Bu, Hex and Oct represent all isomeric propyl, butyl, hexyl and octyl radicals, yet more preferably Cl—, MeO—, EtO—, PrO—, BuO—, HexO—, OctO—, PhO—, hexanoate, laurate or benzoate, wherein Pr, Bu, Hex and Oct represent all isomeric propyl, butyl, hexyl and octyl radicals.

Preferably, R¹⁵ to R²⁰ are hydrogen or alkyl, aralkyl, alkaryl or aryl radicals having up to 20 carbon atoms, particularly preferably hydrogen or alkyl, aralkyl, alkaryl or aryl radicals having up to 12 carbon atoms, most particularly preferably hydrogen, methyl, ethyl, propyl, butyl, hexyl or octyl radicals, wherein propyl, butyl, hexyl and octyl represent all isomeric propyl, butyl, hexyl and octyl radicals.

The units L¹-X, L²-Y and L⁵-Z preferably represent —CH₂CH₂O—, —CH₂CH(Me)O—, —CH(Me)CH₂O—, —CH₂C(Me)₂O—, —C(Me)₂CH₂O— or —CH₂C(═O)O—.

The unit L¹-X-D-Y-L² preferably represents: HN[CH₂CH₂O—]₂, HN[CH₂CH(Me)O—]₂, HN[CH₂CH(Me)O—][CH(Me)CH₂O—], HN[CH₂C(Me)₂O—]₂, HN[CH₂C(Me)₂O—][C(Me)₂CH₂O—], HN[CH₂C(═O)O—]₂, MeN[CH₂CH₂O—]₂, MeN[CH₂CH(Me)O—]₂, MeN[CH₂CH(Me)O—][CH(Me)CH₂O—], MeN[CH₂C(Me)₂O—]₂, MeN[CH₂C(Me)₂O—][C(Me)₂CH₂O—], MeN[CH₂C(═O)O—]₂, EtN[CH₂CH₂O—]₂, EtN[CH₂CH(Me)O—]₂, EtN[CH₂CH(Me)O—][CH(Me)CH₂O—], EtN[CH₂C(Me)₂O—]₂, EtN[CH₂C(Me)₂O—][C(Me)₂CH₂O—], EtN[CH₂C(═O)O—]₂, PrN[CH₂CH₂O—]₂, PrN[CH₂CH(Me)O—]₂, PrN[CH₂CH(Me)O—][CH(Me)CH₂O—], PrN[CH₂C(Me)₂O—]₂, PrN[CH₂C(Me)₂O—][C(Me)₂CH₂O—], PrN[CH₂C(═O)O—]₂, BuN[CH₂CH₂O—]₂, BuN[CH₂CH(Me)O—]₂, BuN[CH₂CH(Me)OACH(Me)CH₂O—][CH(Me)CH₂O—], BuN[CH₂C(Me)₂O—]₂, BuN[CH₂C(Me)₂O—][C(Me)₂CH₂O—], BuN[CH₂C(═O)O—]₂, HexN[CH₂CH₂O—]₂, HexN[CH₂CH(Me)O—]₂, HexN[CH₂CH(Me)13 ][CH(Me)CH₂O—], HexN[CH₂C(Me)₂O—]₂, HexN[CH₂C(Me)₂O—][C(Me)₂CH₂O—], HexN[CH₂C(═O)O—]₂, OctN[CH₂CH₂O—]₂, OctN[CH₂CH(Me)O—]₂, OctN[CH₂CH(Me)O—][CH(Me)CH₂O—], OctN[CH₂C(Me)₂O—]₂, OctN[CH₂C(Me)₂O—][C(Me)₂CH₂O—], OctN[CH₂C(═O)O—]₂, wherein Pr, Bu, Hex and Oct can represent all isomeric propyl, butyl, hexyl and octyl radicals, PhN[CH₂CH₂O—]₂, PhN[CH₂CH(Me)O—]₂, PhN[CH₂CH(Me)O—][CH(Me)CH₂O—], PhN[CH₂C(Me)₂O—]₂, PhN[CH₂C(Me)₂O—][C(Me)₂CH₂O—], PhN[CH₂C(═O)O—]₂,

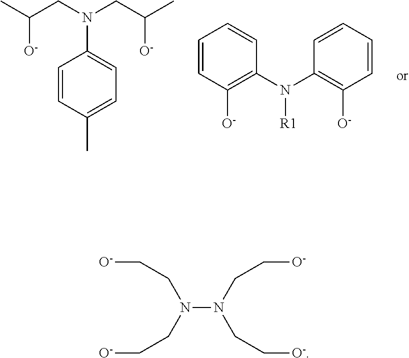

The tin compounds—as is known to the person skilled in the art have a tendency to oligomerisation, so that polynuclear tin compounds or mixtures of mono- and poly-nuclear tin compounds are frequently present. In the polynuclear tin compounds, the tin atoms are preferably bonded with one another via oxygen atoms (“oxygen bridges”, vide intra). Typical oligomeric complexes (polynuclear tin compounds) form, for example, by condensation of the tin atoms via oxygen or sulfur, for example

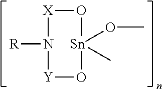

where n>1 (see formula II). There are frequently found at low degrees of oligomerisation cyclic and at higher degrees of oligomerisation linear oligomers having OH or SH end groups (see formula III).

The invention further provides a process fir the preparation of the polyisocyanate polyaddition products according to the invention, wherein
a) at least one aliphatic, cycloaliphatic, araliphatic and/or aromatic polyisocyanate is reacted with
b) at least one NCO-reactive compound in the presence of
c) at least one thermolatent, inorganic, tin-comprising catalyst,
d) optionally further catalysts and/or activators other than c), and
e) optionally fillers, pigments, additives, thickeners, antifoams and/or other auxiliary substances and added ingredients, and
f) a protonic acid in an amount which is at least equimolar based on the catalyst mentioned under c) and not more than equimolar based on the NCO-reactive groups from the compound from b),
wherein the ratio of the weight of the tin from component c) and of the weight of component a) is less than 1000 ppm when component a) is an aliphatic polyisocyanate and less than 80 ppm when component a) is an aromatic polyisocyanate, characterised in that there are used as thermolatent catalysts c) cyclic tin compounds of formula I, II or III:

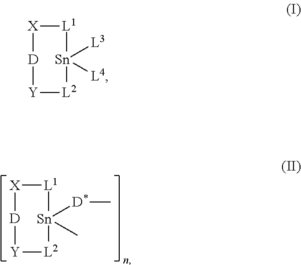

where n>1,

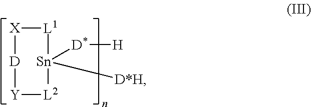

where n>1,
wherein the definitions given above apply for D, D*, Y, X and L¹ to L⁴.

In cases where the tin compounds contain ligands having free OH and/or NH radicals, the catalyst can be incorporated into the product in the polyisocyanate polyaddition reaction. The particular advantage of such incorporable catalysts is their greatly reduced fogging behaviour, which is important especially when polyurethane coatings are used in automotive interiors,

The various preparation methods for the tin(IV) compounds to be used according to the invention or their tin(II) precursors are described inter aila in: WO 2011/113926, J. Organomet. Chem. 2009 694 3184-3189, Chem. Heterocycl. Comp. 2007 43 813-834, Indian J. Chem. 1967 5 643-645 and in literature cited therein.

A number of cyclic tin compounds have already also been proposed for use as a catalyst for the isocyanate polyaddition process, see DD-A 242 617, U.S. Pat. No. 3,164,557, DE-A 1 111 377, U.S. Pat. No. 4,430,456, GB-A 899 948, US-A 2008/0277137. However, it is a common feature of all those prior-described systems of the prior art that the compounds in question are without exception Sn(II) or organotin(IV) compounds.

The catalysts can be combined with further catalysts/activators known from the prior art; for example, titanium, zirconium, bismuth, tin(II) and/or iron-comprising catalysts, such as are described, for example, in WO 2005/058996. The addition of amines or amidines is also possible.

The catalyst according to the invention, optionally predissolved in a suitable solvent, can be added to the reaction mixture together with the NCO-reactive compound (polyol) or the polyisocyanate.

The same is true of the protonic acid to be used according to the invention. It can be used together with the catalyst, for example predissolved in one of the above-mentioned components, but optionally also separately, predissolved in the component that does not comprise the catalyst. A further advantage of the latter procedure is that catalysts which in themselves, that is to say in the absence of protonic acids, are comparatively inactive (which is disadvantageous) but which are generally also less active as regards the undesired reaction of the isocyanate groups with one another (which is advantageous) can be used in solution in the isocyanate component and it is nevertheless possible to obtain comparatively storage-stable preparations which develop the advantages according to the invention only after mixing with the reactant, generally an OH-functional polyether-, polyester-, polyacrylate- and/or polycarbonate-based polyol, which comprises the protonic acid, in the curing reaction.

The polyisocyanates (a) suitable for the preparation of polyisocyanate polyaddition products, in particular polyurethanes, are the organic aliphatic, cycloaliphatic, araliphatic and/or aromatic polyisocyanates having at least two isocyanate groups per molecule which are known per se to the person skilled in the art, and mixtures thereof. Examples of such polyisocyanates are di- or tri-isocyanates, such as, for example, butane diisocyanate, pentane diisocyanate, hexane diisocyanate (hexamethylene diisocyanate, HDI), 4-isocyanatomethyl-1,8-octane diisocyanate(triisocyanatononane, TIN), 4,4′-methylenebis(cyclohexyl isocyanate) (H₁₂MDI), 3,5,5-trimethyl-1-isocyanato-3-isocyanatomethylcyclohexane(isophorone diisocyanate, IPDI), 1,3- and 1,4-bis(isocyanatomethyl)cyclohexane (H₆XDI), 1,5-naphthalene dilsocyanate, diisocyanatodiphenylmethane (2,2′-, 2,4′- and 4,4′-MDI or mixtures thereof), diisocyanatomethylbenzene (2,4- and 2,6-toluene diisocyanate, TDI) and commercial mixtures of the two isomers, as well as 1,3-bis-(isocyanatomethyl)benzene (XDI), 3,3′-dimethyl-4,4′-biphenyl diisocyanate (TODI), 1,4-para-phenylene diisocyanate (PPDI) as well as cyclohexyl diisocyanate, (CHDI) and the higher molecular weight oligomers with biuret, uretdione, isocyanurate, iminooxadiazinedione, allophanate, urethane and carbodiimide/uretonimine structural units obtainable individually or in a mixture from the above. Preference is given to the use of polyisocyanates based on aliphatic and cycloaliphatic diisocyanates.

The polyisocyanate component (a) can be present in a suitable solvent. Suitable solvents are those which exhibit sufficient solubility of the polyisocyanate component and are free of isocyanate-reactive groups. Examples of such solvents are acetone, methyl ethyl ketone, cyclohexartone, methyl isobutyl ketone, methyl isoamyl ketone, diisobutyl ketone, ethyl acetate, n-butyl acetate, ethylene glycol diacetate, butyrolactone, diethyl carbonate, propylene carbonate, ethylene carbonate, N,N-dimethylformamide, N,N-dimethylacetamide, N-methylpyrrolidone, N-ethylpyrrolidone, methylal, ethylal, butylal, 1,3-dioxolane, glycerol formal, benzene, toluene, n-hexane, cyclohexane, solvent naphtha, 2-methoxypropyl acetate (MPA).

The isocyanate component can additionally comprise conventional auxiliary substances and added ingredients, such as, for example, rheology improvers (for example ethylene carbonate, propylene carbonate, dibasic esters, citric acid esters), UV stabilisers (for example 2,6-dibutyl-4-methylphenol), hydrolytic stabilisers (for example sterically hindered carbodiimides), emulsifiers and catalysts (for example trialkylamines, diazabicyclooctane, tin dioctoate, dibutyltin dilaurate, N-alkylmorpholine, lead, zinc, tin, calcium, magnesium octoate, the corresponding naphthenates and p-nitrophenolate and/or also mercuryphenyl neodecanoate) and fillers (for example chalk), colourants which can optionally be incorporated into the polyurethane/polyurea to be formed later (which accordingly have Zerewitinoff-active hydrogen atoms) and/or colouring pigments.

As NCO-reactive compounds (h) there can be used all compounds known to the person skilled in the art which have a mean OH or NH functionality of at least 1.5. They can be, for example, low molecular weight diols (e.g. 1,2-ethanediol, 1,3- and 1,2-propanediol, 1,4-butanediol), triols (e.g. glycerol, trimethylolpropane) and tetraols (e.g. pentaerythritol), short-chained polyamines but also higher molecular weight polyhydroxy compounds such as polyether polyols, polyester polyols, polycarbonate polyols, polysiloxane polyols, polyamines and polyether polyamines as well as polybutadiene polyols. Polyether polyols are obtainable in a manner known per se by alkoxylation of suitable starter molecules with base catalysts or using double metal cyanide compounds (DMC compounds). Suitable starter molecules for the preparation of polyether polyols are, for example, simple, low molecular weight polyols, water, organic polyamines having at least two N—H bonds or arbitrary mixtures of such starter molecules. Preferred starter molecules for the preparation of polyether polyols by alkoxylation, in particular by the DMC process, are in particular simple polyols such as ethylene glycol, 1,3-propylene glycol and 1,4-butanediol, 1,6-hexanediol, neopentyl glycol, 2-ethyl-1,3-hexanediol, glycerol, trimethylolpropane, pentaerythritol as well as low molecular weight, hydroxyl-group-comprising esters of such polyols with dicarboxylic acids of the type mentioned by way of example below, or low molecular weight ethoxylation or propoxylation products of such simple polyols, or arbitrary mixtures of such modified or unmodified alcohols. Alkylene oxides suitable for the alkoxylation are in particular ethylene oxide and/or propylene oxide, which can be used in the alkoxylation in any desired sequence or also in admixture. Polyester polyols can be prepared in known manner by polycondensation of low molecular weight polycarboxylic acid derivatives, such as, for example, succinic acid, adipic acid, suberic acid, azelaic acid, sebacic acid, dodecanedioic acid, tetrahydrophthalic anhydride, hexahydrophthalic anhydride, tetrachlorophthalic anhydride, endomethylenetetrahydrophthalic anhydride, glutaric anhydride, maleic acid, maleic anhydride, fumaric acid, dimer fatty acid, trimer fatty acid, phthalic acid, phthalic anhydride, isophthalic acid, terephthalic acid, citric acid or trimellitic acid, with low molecular weight polyols, such as, for example, ethylene glycol, diethylene glycol, neopentyl glycol, hexanediol, butanediol, propylene glycol, glycerol, trimethylolpropane, 1,4-hydroxymethylcyclohexane, 2-methyl-1,3-propanediol, 1,2,4-butanetriol, triethylene glycol, tetraethylene glycol, polyethylene glycol, dipropylene glycol, polypropylene glycol, dibutylene glycol and polybutylene glycol, or by ring-opening polymerisation of cyclic carboxylic acid esters, such as ε-caprolactone. In addition, hydroxycarboxylic acid derivatives, such as, for example, lactic acid, cinnamic acid or ω-hydroxycaproic acid, can be polycondensed to polyester polyols. However, polyester polyols of oleochemical origin can also be used. Such polyester polyols can be prepared, for example, by complete ring opening of epoxidised triglycerides of an at least partially olefinically unsaturated fatty-acid-comprising mixture with one or more alcohols having from 1 to 12 carbon atoms and by subsequent partial transesterification of the triglyceride derivatives to alkylester polyols having from 1 to 12 carbon atoms in the alkyl moiety. The preparation of suitable polyacrylate polyols is known per se to the person skilled in the art. They are obtained by radical polymerisation of hydroxyl-group-comprising, olefinically unsaturated monomers or by radical copolymerisation of hydroxyl-group-comprising, olefinically unsaturated monomers with optionally other olefinically unsaturated monomers, such as, for example, ethyl acrylate, butyl acrylate, 2-ethylhexyl acrylate, isobornyl acrylate, methyl methacrylate, ethyl methacrylate, butyl methacrylate, cyclohexyl methacrylate, isobornyl methacrylate, styrene, acrylonitrile and/or methacrylonitrile. Suitable hydroxyl-group-comprising, olefinically unsaturated monomers are in particular 2-hydroxyethyl acrylate, 2-hydroxyethyl methacrylate, the hydroxypropyl acrylate isomer mixture obtainable by addition of propylene oxide to acrylic acid, and the hydroxypropyl methacrylate isomer mixture obtainable by addition of propylene oxide to methacrylic acid. Suitable radical initiators are those from the group of the azo compounds, such as, for example, azoisobutyronitrile (AIBN), or from the group of the peroxides, such as, for example, di-tert-butyl peroxide.

Preferably, b) is higher molecular weight polyhydroxy compounds.

Component (b) can be present in a suitable solvent. Suitable solvents are those which exhibit sufficient solubility of the component. Examples of such solvents are acetone, methyl ethyl ketone, cyclohexanone, methyl isobutyl ketone, methyl isoamyl ketone, diisobutyl ketone, ethyl acetate, n-butyl acetate, ethylene glycol diacetate, butyrolactone, diethyl carbonate, propylene carbonate, ethylene carbonate, N,N-dimethylformamide, N,N-dimethylacetamide, N-methylpyrrolidone, N-ethylpyrrolidone, methylal, ethylal, butylal, 1,3-dioxolane, glycerol formal, benzene, toluene, n-hexane, cyclohexane, solvent naphtha, 2-methoxypropyl acetate (MPA). In addition, the solvents can also carry isocyanate-reactive groups. Examples of such reactive solvents are those which have a mean functionality of isocyanate-reactive groups of at least 1.8. They can be, for example, low molecular weight diols (e.g. 1,2-ethanediol, 1,3- and 1,2-propanediol, 1,4-butanediol), triols (e.g. glycerol, trimethylolpropane), but also low molecular weight diamines, such as, for example, polyaspartic acid esters.

The process for the preparation of the polyisocyanate polyaddition products can be carried out in the presence of conventional rheology improvers, stabilisers, UV stabilisers, catalysts, hydrolytic stabilisers, emulsifiers, fillers, optionally incorporable colourings (which accordingly have Zerewitinoff-active hydrogen atoms) and/or colouring pigments. The addition of zeolites is also possible.

Preferred auxiliary substances and added ingredients are blowing agents, fillers, chalk, carbon black or zeolites, flame retardants, colouring pastes, water, antimicrobial agents, flow improvers, thixotropic agents, surface-modifying agents and retarders in the preparation of the polyisocyanate polyaddition products. Further auxiliary substances and added ingredients include antifoams, emulsifiers, foam stabilisers and cell regulators. An overview is given in G. Oertel, Polyurethane Handbook, 2nd Edition, Carl Hamer Verlag, Munich, 1994, Chap. 3.4.

The protonic acids to be used according to the invention can be selected as desired from a large number of substances which appear to the person skilled in the art to be suitable for this purpose. It is important only that they do not enter into negative interactions with the polyurethane matrix or lead to incompatibilities, which can be achieved almost arbitrarily by a suitable choice of the molecular structure of the radical X— in the protonic acid FIX. It is also possible for the protonic acid to be bonded via the radical X in the polymer matrix of the reactant h), which generally carries OH groups, for the isocyanate component a). Thus, many polyacrylates of the prior art comprise acidic protons from the incorporation of (meth)acrylic acid units during their preparation. The resulting acid number is sometimes even so high that the thermolatency of the catalyst system according to the invention suffers, which can readily be adjusted to the desired extent by means of simple preliminary tests with purposive variation of the acid number, buffering with suitable bases, etc.

Finally, it is also possible for the protonic acid to be used according to the invention not to be generated until the curing reaction from suitable precursors such as acid anhydrides, halides, etc., for example by the action of (atmospheric) moisture.

The systems according to the invention can be applied to the object to be coated in solution or from the melt as well as, in the case of powder coatings, in solid form by methods such as brushing, rolling, pouring, spraying, dipping, fluidised bed processes or by electrostatic spraying processes. Suitable substrates are, for example, materials such as metals, wood, plastics materials or ceramics.

Accordingly, the invention further provides coating compositions comprising the polyisocyanate polyaddition products according to the invention, and coatings obtainable therefrom, and substrates coated with those coatings.

### EXAMPLES

The invention is to be explained in greater detail by means of the following examples. In the examples, all percentages are to be understood as being percentages by weight, unless indicated otherwise. All reactions were carried out under a dry nitrogen atmosphere. The catalysts from Table 1 were obtained by standard literature procedures (see Chem. Heterocycl. Comp. 2007 43 813-834 and literature cited therein), DBTL was obtained from Kever Technologic, Ratingen, D.

For better comparability of the activity of the tests carried out by the procedure according to the invention with the comparative examples, the amount of catalyst was given as mg of Sn per kg of (solvent-free) polyisocyanate curing agent (ppm), wherein the commercial product Desmodur®N 3300 from Bayer MaterialScience AG, Leverkusen, Del. was used as the polyisocyanate curing agent, and exactly one equivalent (based on the free isocyanate groups of the polyisocyanate curing agent) of triethylene glycol monomethyl ether, TEGMME (product of Aldrich, Taufkirchen, D) was used as the model compound for the isocyanate-reactive component (‘poly’ol). By adding 10% (based on Desmodur®N 3300) n-butyl acetate, it was ensured that samples having a sufficiently low viscosity could be taken throughout the course of the reaction, which permit precise determination of the NCO content by means of titration according to DIN 53 185. The NCO content calculated at the start of the reaction without any NCO—OH reaction is 10.9+/−0.1%, tests in which the NCO content had fallen to 0.1% or in which the NCO content was still more than 6% after 4 hours' reaction time were terminated.

Comparative test 1 at a constant 30° C. shows the extremely slow fall in the NCO content of the mixture in the uncatalysed case (Table 2, test 1). In order to permit a comparison of the acceleration of the reaction at a ‘curing temperature’ of 60° C. or 80° C. with the uncatalysed case, tests were additionally carried out first at a constant 30° C. (2 hours) and then at 60 or 80° C. without catalysis (Table 2, test 2 and 3). Comparative test 4 represents the “standard case” carried out with dibutyltin dilaurate according to the prior art. Comparative tests 5 to 8 demonstrate the decreasing thermolatency of the systems described in WO 2011/051247 when the dose of catalyst is increased, using the example of the most active of the compounds described in the examples therein (2,2-dichloro-6-methyl-1,3,6,2-dioxazastannocane, “catalyst 3” in WO 2011/051247, “catalyst 1” here). Comparative tests 12 to 15 demonstrate the significantly lower activity when using the spirocyclic Sn(IV) -centred catalysts 2 (4,12-dimethyl-1,7,9,15-tetraoxa-4,12-diaza-8-stannaspiro[7.7]pentadecane), 3 (4,12-dibutyl-1,7,9,15-tetraoxa-4,12-diaza-8-stannaspiro[7,7]pentadecane) and 4 (4,12-dibutyl-2,6,10,14-tetramethyl-1,7,9,15-tetraoxa-4,12-diaza-8-stannaspiro[7.7]pentadecane, isomer mixture), which are structurally similar to catalyst 1 but are halogen-free.

Example 22 (comparison) shows the significantly lower stability of a highly catalysed isocyanate curing agent solution when catalyst 1 is used as compared with catalyst 2.

TABLE 1
Overview of the catalysts used

| | | Empirical | Molecular weight | Sn |
|---|---|---|---|---|
| Catalyst | Structural formula | formula | [g/mol] | content |
| DBTL (comparison) | 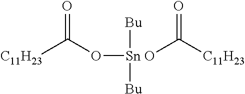 | C₃₂H₆₄O₄Sn | 631.55 | 18.79% |
| Cat. 1 | 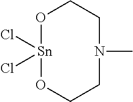 | C₅H₁₁Cl₂NO₂Sn | 306.74 | 38.69% |
| Cat. 2 | 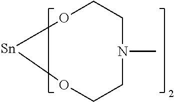 | C₁₀H₂₂N₂O₄Sn | 352.98 | 33.62% |
| Cat. 3 | 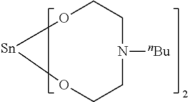 | C₁₆H₃₄N₂O₄Sn | 437.15 | 27.15% |
| Cat. 4 | 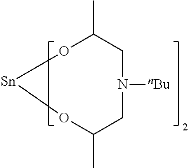 | C₂₀H₄₂N₂O₄Sn | 493.26 | 24.06% |

TABLE 2
Overview of the tests carried out (Examples 1-8 and 12 to 15: comparative
examples, Examples 9-11 and 14-21: according to the invention)

| Ex. | | Cat. | NCO content of the mixture [%] after [hh:mm] | | | | | | | | | |
|---|---|---|---|---|---|---|---|---|---|---|---|---|
| no. | Cat. | conc. ¹⁾ | 00:30 | 1:00 | 1:30 | 2:00 | 2:10 | 2:20 | 2:30 | 3:00 | 3:30 | 4:00 |
| 1 | none | 0²⁾ | 11.0 | 11.0 | 10.9 | 10.9 | 10.9 | 10.9 | 10.9 | 10.9 | 10.9 | 10.9 |
| 2 | none | 0³⁾ | 11.0 | 10.9 | 10.9 | 10.9 | 10.8 | 10.7 | 10.7 | 10.6 | 10.5 | 10.1 |
| 3 | none | 0⁴⁾ | 11.0 | 11.0 | 10.9 | 10.9 | 10.9 | 10.9 | 10.6 | 10.3 | 10.1 | 9.7 |
| 4 | DBTL | 20³⁾ | 10.3 | 9.7 | 9.2 | 8.6 | 8.3 | 7.8 | 7.6 | 2.9 | 1.4 | 0.1 |
| 5 | Cat. 1 | 20³⁾ | 11.0 | 11.0 | 11.0 | 10.9 | 10.8 | 10.7 | 10.3 | 8.0 | 7.3 | 6.2 |
| 6 | Cat. 1 | 40³⁾ | 10.9 | 10.7 | 10.5 | 9.9 | 9.6 | 9.0 | 8.6 | 5.5 | 4.2 | 2.6 |
| 7 | Cat. 1 | 60³⁾ | 10.6 | 10.5 | 10.1 | 9.7 | 9.6 | 9.1 | 5.3 | 2.5 | 1.3 | 0.8 |
| 8 | Cat. 1 | 200³⁾ | 10.1 | 9.2 | 8.3 | 7.6 | 6.9 | 4.5 | 3.5 | 1.0 | 0.2 | — |
| 9 | Cat. 1 | 20^{3), 5)} | 7.5 | 7.0 | 6.2 | 5.7 | 5.2 | 3.7 | 2.8 | 1.5 | 0.9 | 0.2 |
| 10 | Cat. 1 | 20^{3), 6)} | 10.5 | 10.4 | 10.0 | 9.9 | 9.2 | 8.2 | 6.7 | 3.8 | 2.2 | 1.3 |
| 11 | Cat. 1 | 20^{3), 7)} | 10.8 | 10.5 | 10.4 | 10.2 | 9.7 | 8.8 | 7.8 | 5.9 | 3.4 | 2.8 |
| 12 | Cat. 2 | 20³⁾ | 11.0 | 11.0 | 10.9 | 10.9 | 10.7 | 10.5 | 10.3 | 10.0 | 9.7 | 9.5 |
| 13 | Cat. 2 | 60³⁾ | 10.9 | 10.8 | 10.7 | 10.6 | 10.3 | 9.8 | 9.7 | 8.9 | 8.2 | 6.0 |
| 14 | Cat. 3 | 50³⁾ | 11.0 | 11.0 | 11.0 | 11.0 | 10.7 | 10.5 | 10.2 | 9.7 | 9.2 | 8.1 |
| 15 | Cat. 4 | 50³⁾ | 10.9 | 10.7 | 10.7 | 10.6 | 10.5 | 10.2 | 10.1 | 8.6 | 7.5 | 6.8 |
| 16 | Cat. 2 | 20^{3), 5)} | 10.5 | 10.5 | 10.3 | 10.1 | 10.1 | 8.7 | 6.1 | 1.3 | 0.5 | — |
| 17 | Cat. 2 | 20^{3), 8)} | 11.0 | 11.0 | 11.0 | 11.0 | 10.9 | 10.7 | 10.5 | 9.8 | 9.0 | 8.3 |
| 18 | Cat. 2 | 60^{3), 8), 9)} | 10.5 | 10.5 | 10.4 | 10.4 | 10.2 | 9.8 | 9.5 | 8.5 | 6.6 | 4.2 |
| 19 | Cat. 2 | 60^{3), 10)} | 10.5 | 10.3 | 10.1 | 10.0 | 9.7 | 8.1 | 4.8 | 0.2 | — | — |
| 20 | Cat. 3 | 50^{3), 5)} | 10.8 | 10.0 | 9.8 | 9.7 | 9.2 | 3.3 | 0.9 | — | — | — |
| 21 | Cat. 4 | 50^{3), 10)} | 11.0 | 10.6 | 10.4 | 10.1 | 9.8 | 7.0 | 6.2 | 0.6 | — | — |

¹⁾ Sn [ppm] on polyisocyanate curing agent
²⁾constant 30° C.; after 97 h at 30° C.: 8.9% NCO
³⁾first 2 h 30° C., then 60° C.
⁴⁾first 2 h 30° C., then 80° C.
⁵⁾1% acetic acid on TEGMME
⁶⁾0.1% acetic acid on TEGMME
⁷⁾0.15% terephthalic acid on TEGMME
⁸⁾0.25% acetic acid on TEGMME
⁹⁾after 4:30: 0.5%
¹⁰⁾0.5% acetic acid on TEGMME

### Example 22

Solutions, saturated by stirring for 3 days at 50° C. with excess catalyst 1 or 2 (solid) and then filtered, of
a) catalyst 1 (after filtration 22.5% NCO content, viscosity 1500 mPas at 23° C.)
   and
b) catalyst 2 (after filtration 22.7% NCO content, viscosity 1250 mPas at 23° C.)
   in Desmodur N 3600, commercial product from Bayer MaterialScience AG, Leverkusen, D, were stored at 50° C. in a drying cabinet. After being stored for 6 months, the mixture from Example 22a) had gelled completely. The mixture from Example 22b), on the other hand, had changed only slightly and had the following data: 21.9% NCO content, 1860 mPas at 23° C.

1.-15. (canceled)

16. A polyisocyanate polyaddition product obtained from
a) at least one aliphatic, cycloaliphatic, araliphatic and/or aromatic polyisocyanate,
b) at least one NCO-reactive compound,
c) at least one inorganic, tin-comprising catalyst,
d) optionally further catalysts and/or activators other than c),
e) optionally fillers, pigments, additives, thickeners, antifoams and/or other auxiliary substances and added ingredients, and
f) a protonic acid in an amount which is at least equimolar based on the catalyst mentioned under c) and not more than equimolar based on the NCO-reactive groups from the compound from b),
wherein the ratio of the weight of the tin from component c) and of the weight of component a) is less than 1000 ppm when component a) is an aliphatic polyisocyanate and less than 80 ppm when component a) is an aromatic polyisocyanate,
wherein the catalyst c) is a cyclic tin compound of formula I, II or III: 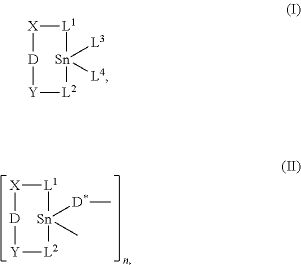
where n>1, 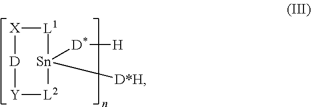
where n>1,
wherein
D represents —O—, —S— or —N(R¹)—,
wherein R¹ represents a saturated or unsaturated, linear or branched, aliphatic or cycloaliphatic or an optionally substituted, aromatic or araliphatic radical having up to 20 carbon atoms, which can optionally comprise heteroatoms from the group oxygen, sulfur, nitrogen, or represents hydrogen or the radical 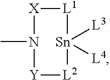
or R1 and L3 together represent —Z-L⁵-, and
D* represents —O— or —S—, and
X, Y and Z represent the same or different radicals selected from alkylene radicals of the formula —C(R²)(R³)—, —C(R²)(R³)—C(R⁴)(R⁵)— or —C(R²)(R³)—C(R⁴)(R⁵)—C(R⁶)(R⁷)— or ortho-arylene radicals of the formula 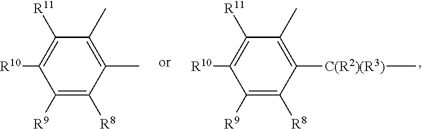
wherein R² to R¹¹ independently of one another represent saturated or unsaturated, linear or branched, aliphatic or cycloaliphatic or optionally substituted, aromatic or araliphatic radicals having up to 20 carbon atoms, which can optionally comprise heteroatoms from the group oxygen, sulfur, nitrogen, or represent hydrogen, and
L¹, L² and L⁵ independently of one another represent —O—, —S—, —OC(═O)—, —OC(═S)—, —SC(═)—, —SC(═S)—, —OS(═O)₂O—, —OS(═O)₂— or —N(R12)—,
wherein R¹² represents a saturated or unsaturated, linear or branched, aliphatic or cycloaliphatic or an optionally substituted, aromatic or araliphatic radical having up to 20 carbon atoms, which can optionally comprise heteroatoms from the group oxygen, sulfur, nitrogen, or represents hydrogen; and
L³ and L⁴ independently of one another represent —OH, —SH, —OR¹³, -Hal, —OC(═O)R¹⁴, —SR¹⁵, —OC(═S)R¹⁶, —OS(═O)₂OR¹⁷, —OS(═O)₂R¹⁸ or —NR¹⁹R²⁰, or L³ and L⁴ together represent -L¹-X-D-Y-L²-,
wherein R¹³ to R²⁰ independently of one another represent saturated or unsaturated, linear or branched, aliphatic or cycloaliphatic or optionally substituted, aromatic or araliphatic radicals having up to 20 carbon atoms, which can optionally comprise heteroatoms from the group oxygen, sulfur, nitrogen, or represent hydrogen.

17. The polyisocyanate polyaddition product according to claim 16, wherein L³ and L⁴ together represent -L¹-X-D-Y-L².

18. The polyisocyanate polyaddition product according to claim 16, wherein D is —N(R¹)— and R¹ is hydrogen or an alkyl, aralkyl, alkaryl or aryl radical having up to 20 carbon atoms, or is the radical

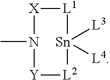

19. The polyisocyanate polyaddition product according to claim 17, wherein R¹ is hydrogen or a methyl, ethyl, propyl, butyl, hexyl, octyl, Ph-, or CH₃Ph- radical or is the radical 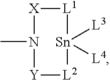
and wherein propyl, butyl, hexyl and octyl represent all isomeric propyl, butyl, hexyl and octyl radicals.

20. The polyisocyanate polyaddition product according to claim 16, wherein D* is —O—.

21. The polyisocyanate polyaddition product according to claim 16, wherein X, Y and Z independently of one another are alkylene radicals of the formula —C(R²)(R³)— or —C(R²)(R³)—C(R⁴)(R⁵)— or ortho-arylene radicals of the formula 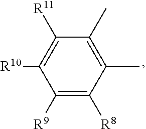
and R² to R⁵ independently of one another are hydrogen, alkyl, aralkyl, alkaryl or aryl radicals having up to 20 carbon atoms, and R⁸ to R¹¹ independently of one another are hydrogen or alkyl radicals having up to 8 carbon atoms.

22. The polyisocyanate polyaddition product according to claim 20, wherein the radicals R² to R⁵ independently of one another are hydrogen or alkyl radicals having up to 8 carbon atoms, and R⁸ to R¹¹ independently of one another are hydrogen or methyl.

23. The polyisocyanate polyaddition product according to claim 16, wherein L¹, L² and L⁵ independently of one another are —N(R¹²)—, —S—, —SC(═S)—, —SC(═O)—, —OC(═S)—, —O— or —OC(═O)—, and R¹² is hydrogen or an alkyl, aralkyl, alkaryl or aryl radical having up to 20 carbon atoms.

24. The polyisocyanate polyaddition product according to claim 22, wherein L¹, L² and L⁵ independently of one another are —N(H)—, —N(CH₃)—, —N(C₂H₅)—, —N(C₄H₉)—, —N(C₈H₁₇)—, —N(C₆H₅)—, —S—, —SC(═S)—, —SC(═O)—, —OC(═S)—, —O— or —OC(═O)—.

25. The polyisocyanate polyaddition product according to claim 16, wherein L³ and L⁴ independently of one another are —OH, —SH, —OR¹³, -Hal or —OC(═O)R¹⁴, and the radicals R¹³ and R¹⁴ have up to 20 carbon atoms.

26. The polyisocyanate polyaddition product according to claim 24, wherein L³ and L⁴ independently of one another are Cl—, MeO—, EtO—, PrO—, BuO—, HexO—, OctO—, PhO—, formate, acetate, propanoate, butanoate, pentanoate, hexanoate, octanoate, laurate, lactate or benzoate, wherein Pr, Bu, Hex and Oct represent all isomeric propyl, butyl, hexyl and octyl radicals.

27. A process for the preparation of the polyisocyanate polyaddition product according to claim 16, comprising reacting
a) at least one aliphatic, cycloaliphatic, araliphatic and/or aromatic polyisocyanate,
b) at least one NCO-reactive compound,
c) at least one inorganic, tin-comprising catalyst,
d) optionally further catalysts and/or activators other than c),
e) optionally fillers, pigments, additives, thickeners, antifoams and/or other auxiliary substances and added ingredients, and
f) a protonic acid in an amount which is at least equimolar based on the catalyst mentioned under c) and not more than equimolar based on the NCO-reactive groups from the compound from b),
with one another, wherein the ratio of the weight of the tin from component c) and of the weight of component a) is less than 1000 ppm when component a) is an aliphatic polyisocyanate and less than 80 ppm when component a) is an aromatic polyisocyanate, wherein the catalyst c) is a cyclic tin compound of formula I, II or III: 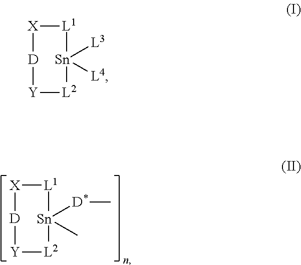
where n>1, 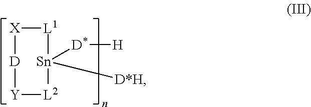
where n>1,
wherein
D represents —O—, —S— or —N(R¹)—,
wherein R¹ represents a saturated or unsaturated, linear or branched, aliphatic or cycloaliphatic or an optionally substituted, aromatic or araliphatic radical having up to 20 carbon atoms, which can optionally comprise heteroatoms from the group oxygen, sulfur, nitrogen, or represents hydrogen or the radical 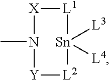
or R1 and L3 together represent —Z-L⁵- and,
D* represents —O— or —S—, and
X, Y and Z represent the same or different radicals selected from alkylene radicals of the formula —C(R²)(R³)—, —C(R²)(R³)—C(R⁴)(R⁵)— or —C(R²)(R³)—C(R⁴)(R⁵)—C(R⁶)(R⁷)— or ortho-arylene radicals of the formula 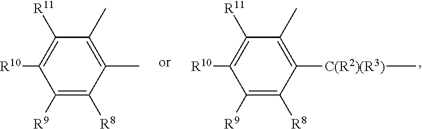
wherein R² to R¹¹ independently of one another represent saturated or unsaturated, linear or branched, aliphatic or cycloaliphatic or optionally substituted, aromatic or araliphatic radicals having up to 20 carbon atoms, which can optionally comprise heteroatoms from the group oxygen, sulfur, nitrogen, or represent hydrogen, and
L¹, L² and L⁵ independently of one another represent —O—, —S—, —OC(═O)—, —OC(═S)—, —SC(═)—, —SC(═S)—, —OS(═O)₂O—, —OS(═O)₂— or —N(R12)—,
wherein R¹² represents a saturated or unsaturated, linear or branched, aliphatic or cycloaliphatic or an optionally substituted, aromatic or araliphatic radical having up to 20 carbon atoms, which can optionally comprise heteroatoms from the group oxygen, sulfur, nitrogen, or represents hydrogen; and
L³ and L⁴ independently of one another represent —OH, —SH, —OR¹³, -Hal, —OC(═O)R¹⁴, —SR¹⁵, —OC(═S)R¹⁶, —OS(═O)₂OR¹⁷, —OS(═O)₂R¹⁸ or —NR¹⁹R²⁰, or L³ and L⁴ together represent -L¹-X-D-Y-L²-,
wherein R¹³ to R²⁰ independently of one another represent saturated or unsaturated, linear or branched, aliphatic or cycloaliphatic or optionally substituted, aromatic or araliphatic radicals having up to 20 carbon atoms, which can optionally comprise heteroatoms from the group oxygen, sulfur, nitrogen, or represent hydrogen.

28. A coating composition comprising the polyisocyanate polyaddition product according to claim 16.

29. A coating obtained from the coating composition according to claim 28.

30. A substrate coated with the coating of claim 29.
